(19) United States
(12) Patent Application Publication
(10) Pub. No.: US 2008/0225130 A1
(43) Pub. Date: Sep. 18, 2008

(54) Method for Extracting of Multiple Sub-Windows of a Scanning Area by Means of a Digital Video Camera

(75) Inventors: Jouni Paaaho, Tampere (FI); Jussi Impio, Palkane (FI); Timo Koskinen, Toijala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 11/722,652

(22) PCT Filed: Dec. 23, 2004
(86) PCT No.: PCT/IB04/04267

§ 371 Date: Oct. 11, 2007

(51) Int. Cl. H04N 5/228; G06K 9/32

(52) U.S. Cl. 348/222.1; 382/298; 348/E05.031

(57) ABSTRACT

The present invention relates to the field of extracting a plurality of sub-windows of a scanning area of an external object to be scanned by means of a digital video camera providing a digital video stream of said scanning area. In a first step a defining of a size and a position for each of one or more sub-windows from said plurality of sub-windows representing one or more regions of interest within said scanning area is provided. Next a extracting of said defined one or more sub-windows from said digital video stream of said scanning area is provided, wherein said extracting is substantially simultaneously done if more than one sub-window from said plurality of sub-windows is defined follows. Further, a digital camera adapted for extracting of sub-windows of a scanning area is provided.

The present invention relates to the field of extracting of sub-windows of a scanning area by means of a digital video camera providing a digital video stream of said scanning area. Further, a digital camera adapted for extracting of sub-windows of a scanning area is provided.

Usually digital video cameras are equipped with digital video sensors adapted for providing video data of the area that a user of said camera wants to capture. These digital video sensors are CCD (charge coupled device) sensors or CMOS sensors for instance, both of them allowing digitally scanning of an area of interest delivering a digital video stream of said area.

CCD image sensors are electronic devices that are capable of transforming a light pattern (image) into an electric charge pattern (an electronic image). The CCD consists of several individual elements that have the capability of collecting, storing and transporting electrical charge from one element to another. Together with the photosensitive properties of silicon this is used to design image sensors. Each photosensitive element will then represent a picture element (pixel).

CCD image sensors can be a color sensor or a monochrome sensor. In a color image sensor an integral RGB color filter array provides color response and separation. A monochrome image sensor senses only in black and white.

Another important issue is the number of pixel provided by a digital image sensor. For instance a 3 Mega Pixel camera comprises a digital image sensor having ca. 2048×1536 pixels. Horizontal pixels refer to the number of pixels in a row of the image sensor. Vertical pixels refer to the number of pixels in a column of the image sensor. The greater the number of pixels, the better the resolution. For example, VGA resolution is (640×480), this means the number of horizontal pixels is 640 and the number of vertical pixels is 480. Pixels are usually square but can sometimes be rectangular.

For the sake of completeness the functionality of a CMOS (complementary metal oxide semiconductors) image sensor is described. CMOS image sensors operate at lower voltages than CCDs, reducing power consumption for portable applications. Each CMOS active pixel sensor cell has its own buffer amplifier, and can be addressed and read individually. A commonly used cell has four transistors and a photo-sensing element.

In addition to their lower power consumption when compared with CCDs, CMOS image sensors are generally of a much simpler design; often just a crystal and a decoupling device. For this reason, they are easier to design with, generally smaller, and require less support circuitry. Digital CMOS image sensors provide digital output, typically via a 4/8 or 16 bit bus. The digital signal is direct, not requiring transference or conversion via a video capture card.

The digital signal representing the image of an area is thus ready to be processed within the digital camera. A modern camera comprises a CPU so that image processing may be provided directly on the camera device. By means of an optical system, which is part of a camera a desired window or area is focused on an image sensor which subsequently delivers a digital video stream in accordance with the scanned area.

It is already known that a digital video camera is able to digitally zoom a desired object or a desired area. Digital zooming enables zooming on a subject beyond the range provided by the optical zoom lens. Digital zooming crops the center of the digital picture and resizes the new cropped picture to the size of the selected resolution. But digitally zooming like this uses the whole sensor or video data delivered by the sensor, respectively and it becomes impossible to track areas which are not in said region.

Also known are digital cameras working by means of motion detection or like. US 2004/0100560 disclose a digital video camera and method that employs a motion detection algorithm to keep a camera locked onto an image when recoding digital video images. Additionally, the motion detection algorithm extracts video frames from the sensor images, such that the resulting video image will track the scene, despite of camera motion.

However, the prior art does not disclose any method of using digital video data of regions which are not directly under observation.

The object of the present invention is to provide a methodology and a digital camera device for extracting of sub-windows of a scanning area by means of a digital video camera, which overcomes the deficiencies of the state of the art.

The objects of the present invention are solved by the subject matter defined in the accompanying independent claims.

According to a first aspect of the present invention, a method for extracting a plurality of sub-windows of a scanning area of an external object to be scanned is provided. Said providing is done by means of a digital video camera providing a digital video stream of said scanning area. In a first step a defining a size and a position for each of one or more sub-windows from said plurality of sub-windows representing one or more regions of interest within said scanning area is provided. Next a extracting of said defined one or more sub-windows from said digital video stream of said scanning area is provided, wherein said extracting is substantially simultaneously done if more than one sub-window from said plurality of sub-windows is defined. The scanning area corresponds to the digital video data delivered by the image sensor and said sub-window is a defined part of said scanning area. This means that in a first approach just a defined part/portion of the whole scanning area (digital image) is regarded. Thus, the possibility of capturing more than one window within the scanning area is given, thereby rendering it possible to record more than one object located within the area to be scanned.

According to an embodiment of the present invention, parameters for extracting said defined one or more sub-windows are provided, wherein said parameters are user input parameters. By means of said parameters it is possible to define certain conditions relating to the sub-window. However a user may manually select the window size or other parameters, which makes said methodology more flexible in accordance with the present invention.

According to another embodiment of the present invention, said defining is automatically performed and is based on detecting of an event, said event being detected within said scanning area. Thereby automatically tracking of a region of interest within the scanning area is enabled. For instance an event handling mechanism processes the digital video data for the whole field of view (whole sensor area data) and detects certain events like pixel changes or even content based event tracking like object identifying. Said identifying may use signal processing algorithms like face detection or shape detection etc.

According to another embodiment of the present invention, said event is detected and signalized on the basis of motion detection, voice tracking or the like within said scanning area. Thereby usage of different detecting and signalizing algorithms is enabled.

According to another embodiment of the present invention, displaying said defined one or more sub-windows is provided and storing video data relating to said defined one or more sub-windows as well. Thereby, it is possible to provide previewing of pictures and also storing of different video streams.

According to another embodiment of the present invention, interpolating of said defined one or more sub-windows is provided. Therewith better quality is achieved and additionally a format adaptation of the video format may be provided.

According to another aspect of the present invention, a computer program product is provided, which comprises program code sections stored on a machine-readable medium for carrying out the operations of the method according to any aforementioned embodiment of the invention, when the computer program product is run on a processor-based device, a computer, a terminal, a network device, a mobile terminal, or a mobile communication enabled terminal.

According to another aspect of the present invention, a computer program product is provided, comprising program code sections stored on a machine-readable medium for carrying out the operations of the aforementioned method according to an embodiment of the present invention, when the computer program product is run on a processor-based device, a computer, a terminal, a network device, a mobile terminal, or a mobile communication enabled terminal.

According to another aspect of the present invention, a software tool is provided. The software tool comprises program portions for carrying out the operations of the aforementioned methods when the software tool is implemented in a computer program and/or executed.

According to another aspect of the present invention, a computer data signal embodied in a carrier wave and representing instructions is provided which when executed by a processor causes the operations of the method according to an aforementioned embodiment of the invention to be carried out.

According to another aspect of the present invention, a digital camera device adapted for extracting a plurality of sub-windows of a scanning area of an external object to be scanned is provided, said digital camera device providing a digital video stream of said scanning area. Said camera device is equipped with a module for defining a size and a position for each of one or more sub-windows from said plurality of sub-windows representing one or more regions of interest within said scanning area and additionally with a module for extracting said defined one or more sub-windows from said digital video stream of said scanning area, wherein said extracting module is adapted to substantially simultaneously extract said defined more than one sub-windows if more than one sub-window from said plurality of sub-windows is defined.

According to yet another embodiment of the present invention, said digital camera device further comprises a module for additionally defining a second size and second position of a second sub-window representing a second region of interests within said scanning area.

According to yet another embodiment of the present invention, said digital camera device further comprises: a display for displaying said plurality of sub-windows and for displaying output data for a user, a memory for storing video data relating to said plurality of sub-windows, a digital image sensor in connection with an optical system, and an input module adapted to receive user input. Further, it may be possible to display said plurality of sub-windows at the same time on said device display.

According to yet another embodiment of the present invention, said digital camera device is equipped with a CPU adapted to generally control the camera functionality.

The accompanying drawings are included to provide a further understanding of the invention, and are incorporated in and constitute a part of this specification. The drawings illustrate embodiments of the present invention and together with the description serve to explain the principles of the invention. In the drawings,

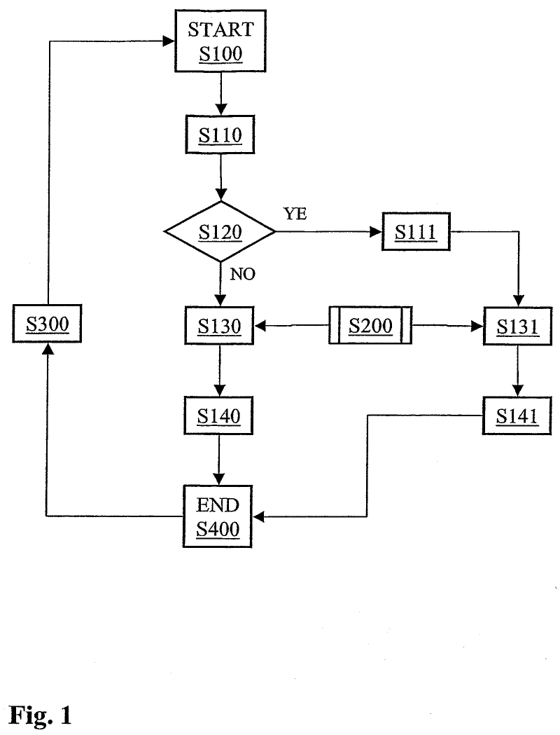

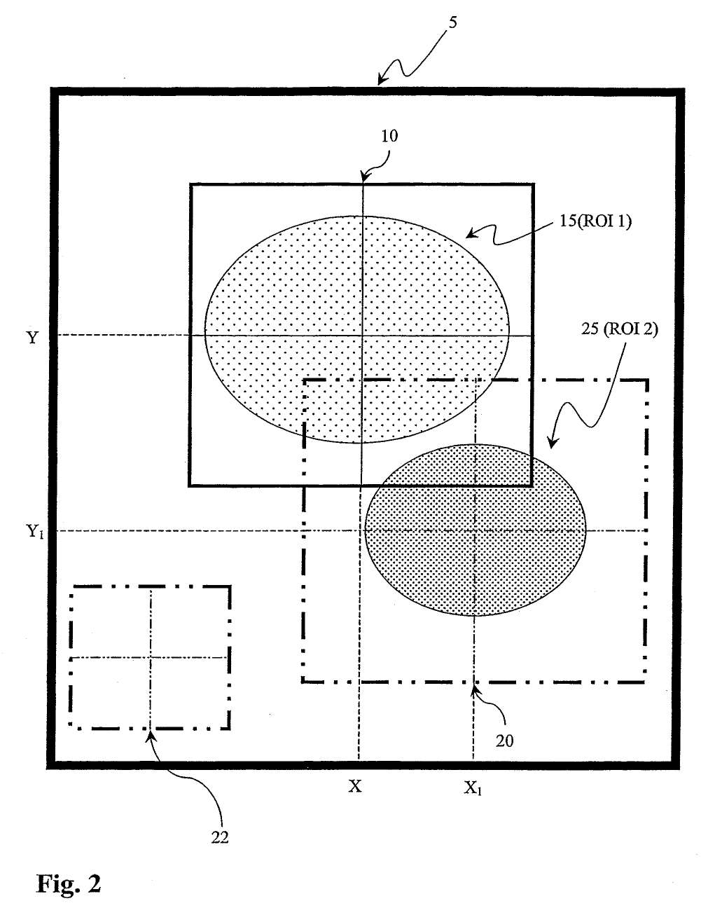

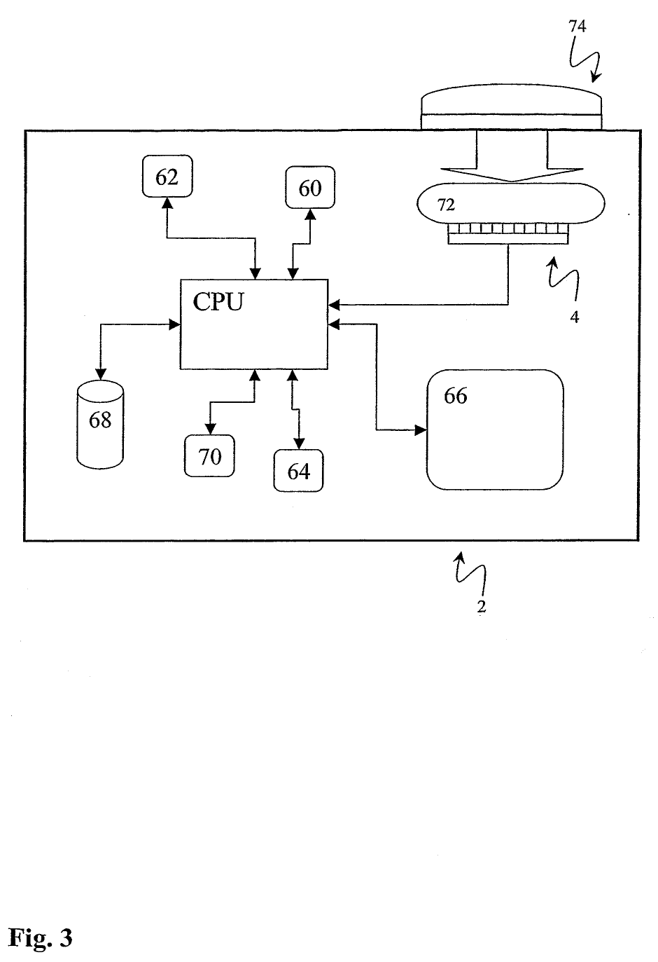

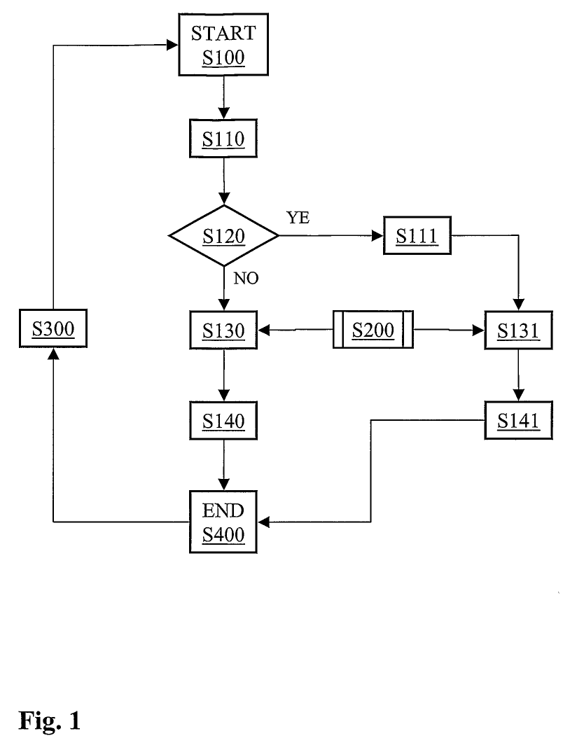

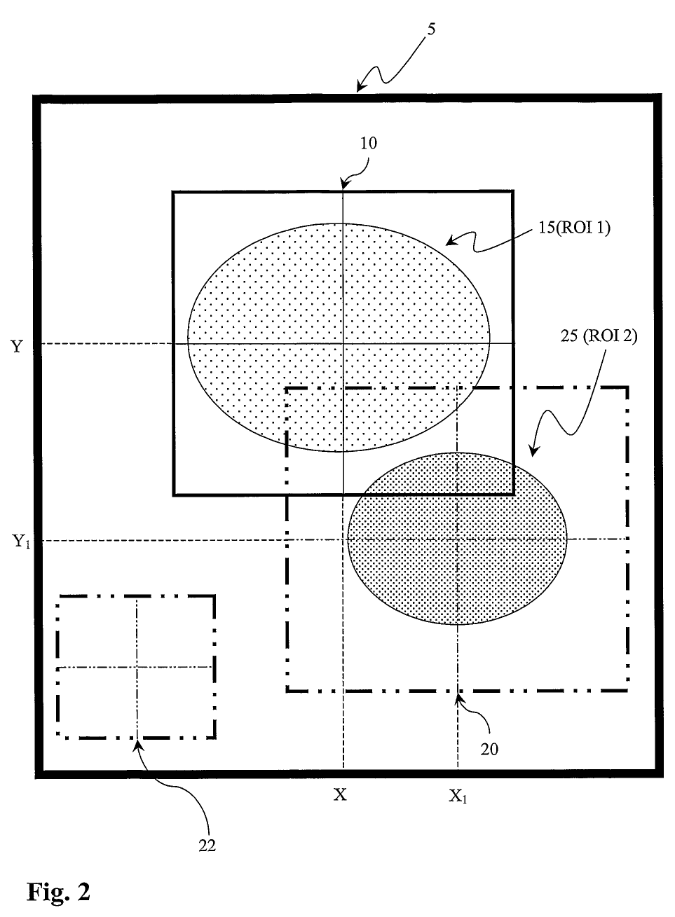

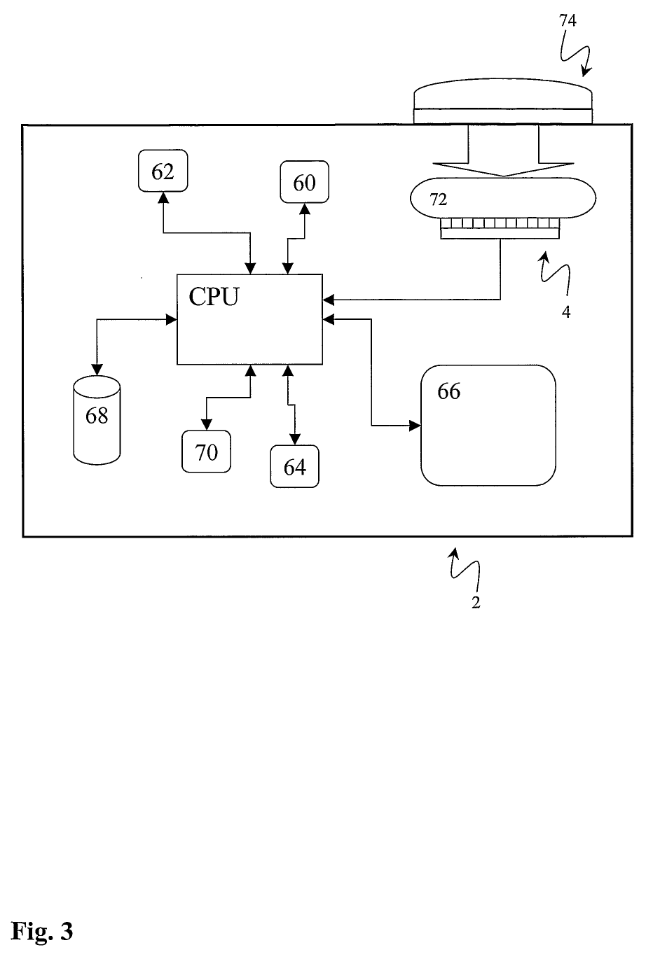

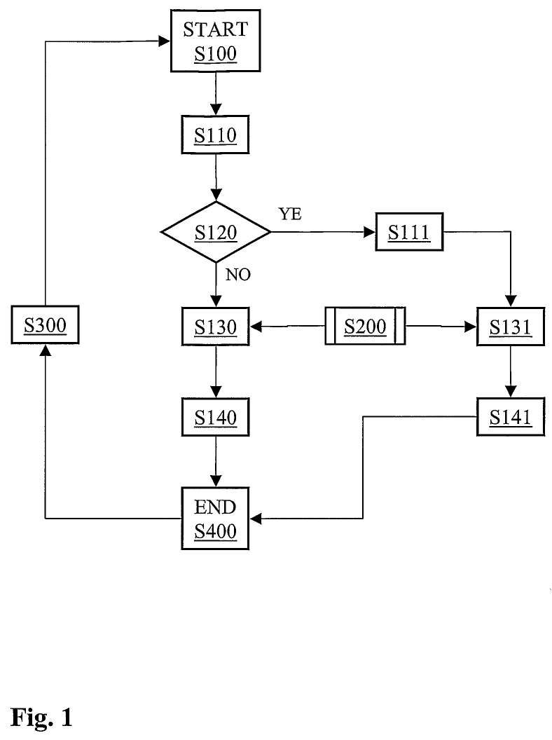

FIG. 1 shows a flow chart illustrating a method for extracting a portion of a scanning area in accordance with the present invention;

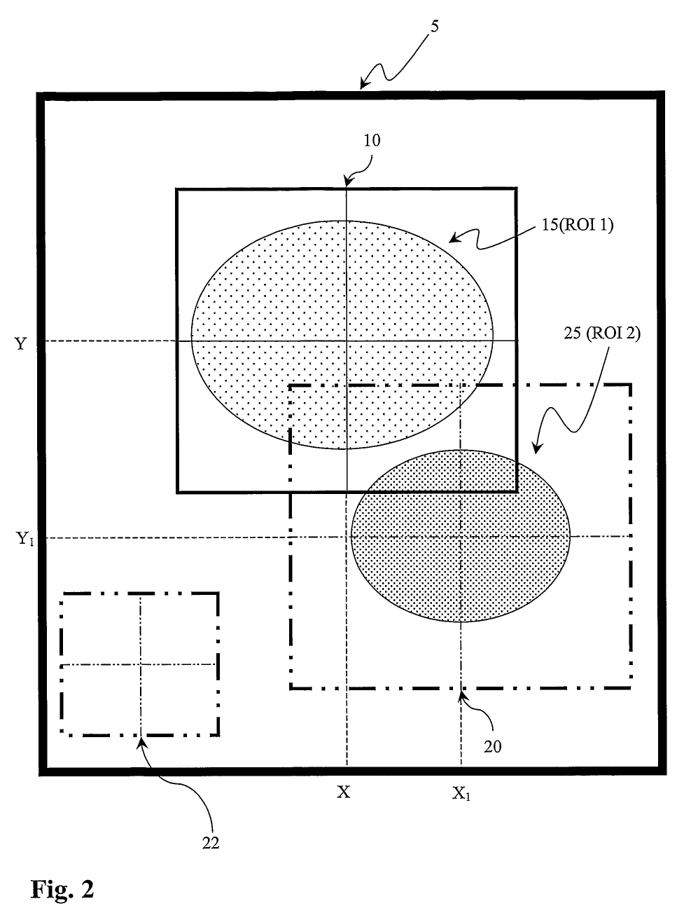

FIG. 2 depicts the principle of window extracting on which the methodology of the present invention is based;

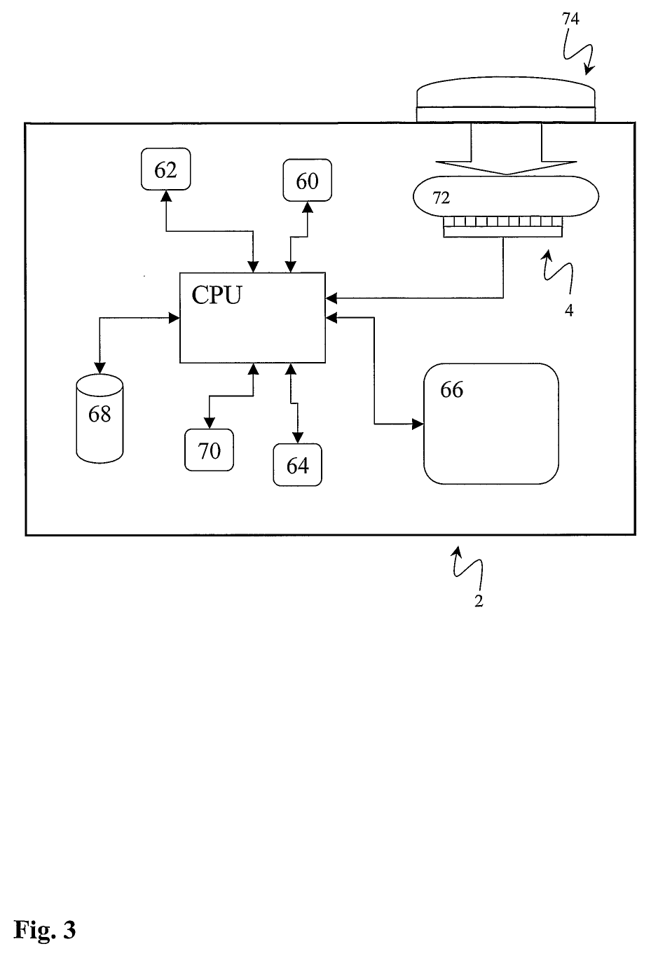

FIG. 3 shows an exemplarily embodiment of a digital camera device according to the present invention.

Even though the invention is described above with reference to embodiments according to the accompanying drawings, it is clear that the invention is not restricted thereto but it can be modified in several ways within the scope of the appended claims.

For instance, a large 3 mega pixel camera sensor fitted with wide-angle lens as part of an optical system is capable to scan about 100° describing the field of view. Such a camera is able of recording almost all attendants around a meeting room table with a single shot. However for video recording the amount of pixels is so small (i.e. PAL needs 768×576 pixel) that details would not be visible if the whole view is to be recorded. Therefore a smaller region from the camera is used for video recording in order to achieve the proper size. Said smaller region has also a smaller field of view, corresponding to ca. 37.5°, which is suitable for this use case. The region may be moved around the whole sensor area, therefore panning without moving the camera in accordance with the present invention may be provided.

Further, image stabilization may be provided while the camera is being moved. By usage of interpolation algorithms the area can be resized to achieve a zoom like behavior.

With reference to FIG. 1, a flow chart illustrating the principle of the present invention is shown. In an operation S100, the operational sequence starts. In accordance with the aforementioned description of the inventive concept, a digital video stream is provided by means of an image sensor. Said image sensor scans an area that is being selected by the user carrying the digital camera. By means of an optical system the light coming from the area to be scanned is focused on the surface of the digital image sensor. Each point, light sensitive element on the image sensor surface corresponds to a data pixel which is part of a digital video stream. The approach that each light sensitive element defines a data pixel in said data stream shall be sufficient in the first approach.

In an operation S110 a defining of a first size and a first position of a first sub-window in accordance with the present invention is provided. Said first sub-window relates to a certain area of the scanning area which is captured by the image sensor. This means that firstly not all scanning area, respectively all data delivered by the image sensor is used which corresponds to an under using of said image sensor. For instance, a user will see on the pre-viewing display his desired scanning area but the sensor will scan the area surrounding said desired area as well. Thus, the methodology in accordance with the present invention allows an indirect surveillance of additional adjacent areas within the scanning area.

Alternatively the area of the image sensor not corresponding to the scanning area may be disabled in order to conserve power.

Either embodiment also allows a subsequent panning without moving the camera device. Said panning is a soft-panning or a software panning. Said panning is therefore possible because the video stream includes more than the desired scanning area in a first approach. Another imaginable use case is the usage of the surrounding area for image stabilization. In an alternative arrangement wherein a part of the image sensor is disabled soft-panning or software panning may be achieved by activating areas of the scanning area which correspond with the location of the sub-window. As the sub-window location moves areas of the scanning area may be subsequently enabled. The present invention will be further described with reference to the first approach only.

In an operation S120 a decision of defining an additional window is provided. Said decision may be executed on the basis of certain parameters, for instance user input or like. Thus, the user is able to choose an additional window for capturing, wherein said additional shall be within the original scanning area provided due to the optical system and the image sensor in the form of a CCD sensor, for instance.

With reference to the NO branch of the conditional operation S120, just a single window for the subsequent extracting shall be used. Next, an operation S130 corresponding to the extraction of the desired window area is provided. Consequently firstly only a part of the data delivered by the image sensor is used. It is possible to discard the remaining data delivered by the CCD sensor because of memory saving issues, but storing of said data may be advantageous for further processing. Thus, an indirect recording of the adjacency of said desired window is done and a user may reuse this data later.

In an operation S200 motion detection, voice detection or the like may be provided which may be used during image recording. According to the information delivered by the motion detection with reference to operation S200 a selective image recording may be provided. It is also imaginable that a plurality of sub-windows to be captured are selected and the operation S200 controls which window shall be captured and subsequently recorded or stored, corresponding to an operation S140. Thus, S200 enables for instance capturing of a vivid discussion of a social event.

The YES branch of the conditional operation S120 is similar to the NO branch with the only difference that an additional window will simultaneously be recorded. The camera device executing the operational sequence in accordance with the present invention is now enabled to record multiple areas within an original scanning area of an image sensor.

In an operation S131 an extraction of an additional sub-window within the scanning are is provided. A defining of a size and position of this second window is previously done in an operation S111 analogous to said operation S10. Said extraction can be done on the basis of a selective operation S200 by means of motion detection, for instance. After extracting said desired sub-window a storing operation S141 may follow, which allows for example storing of the video data into a memory device. However, in this exemplary embodiment only two sub-windows are recorded, but it is conceivable to choose a plurality of windows within the area. If no further processing is carried out the method comes to an end at step S400.

It is also possible to execute both (or more) extracting operations S130 and S131 in an interleaved manner, so that a delay between the recorded video streams is provided. In this arrangement the interleaved recorded video streams form at least part of a digital video stream; each recorded video stream is associated with a sub window.

According to one possible implementation of the present invention a method for simultaneously recording of more than one window of a scanning area is provided. For instance if a user points the camera to the right side of a stage, said camera is now enabled to record the right and the left side of the stage at the same time according to the present invention.

A further embodiment may provide tracking and capturing of individual actors acting on a stage, wherein the selecting of the persons to be tracked is done on the basis of user input parameters or similar. The motion detection for instance detects the movement of certain persons on the stage and if said person is within said scanning area the camera will capture these movements.

Further a time controlled capturing also represented by operation S200 is imaginable, so that a device will record a desired area or areas on a time dependent basis.

If no further processing is carried out the method comes to an end at step S400 and it may be restarted in accordance with an operation S300 corresponding to a new iteration of the above mentioned methodology.

FIG. 2 illustrates the principle on which the method in accordance with the present invention is based. The emphasized area 5 is representing the whole scanning area provided by means of an image sensor. The optical system which is part of a digital camera focuses the light coming from the desired area and the image sensor delivers the digital data in form of a digital video stream. The image sensor maps a certain field of view; said field of view is defined by means of an optical lens included in the optical system. For instance, the sub-window 10 symbolizes the area which a user wants to record. However the camera processes the whole area 5, even if the recording occurs only basing on the sub-window 10. The window 10 is focused on a first area of interest symbolizing something that a user wants to record.

X and Y symbolize the position of the window 10 within the whole scanning area 5 defined by the image sensor. It is also conceivable that the size of said window is varied so that only a small part of the entire sensor surface is used in first approach. By means of interpolation algorithms the captured image may be interpolated, so that a desired resolution may be reached.

As aforementioned, the camera provides motion estimation and detection, thus the motion vectors delivered by the motion estimation process may be used for motion compensative interpolation or for image improving. A skilled person will perceive a lot of possibilities for post processing the data delivered by the image sensor, including picture stabilization, edge detection or like. Image signal processing delivers a lot of variation to achieve general image improvement.

The position (X,Y) and the size of said window 10 may be varied in different ways in accordance with the present invention.

The second window 20 represents another region of interest within the whole scanning area 5. A user or an automatic operation may select said window 20 having a different position in (X₁,Y₁) the sensor surface. The second region of interest 15 represents an area wherein an event is occurred so that a additional recording of this area may be provided on the basis of the methodology according to the present invention.

For the sake of completeness a third window 22 pointing on a third area is represented, but a plurality of different windows is imaginable.

With reference to FIG. 2 the size of each window is different so that a further post processing of the digital video data relating to each window is to be done. For displaying one window on a PAL system a interpolation is necessary. As aforementioned PAL needs 768×576 pixels for proper representation. Each window may deliver more or less window information so that the interpolation process has to map the proper image size.

A panning or soft-panning without moving the camera is possible as well because the digital information of the whole scanning area is provided and the user focuses only on one window from the plurality of imaginable windows. Thus, window 10 may slide within the sensor area, which corresponds to said soft-panning (software panning).

With reference to FIG. 3, the digital camera device 2 shall be realized on the basis of a processor-based electronic device which comprises typically a CPU. Said camera comprises a plurality of modules, wherein each module is connected directly or indirectly to a CPU. The CPU is adapted to control all operations within the camera.

A memory unit 68 being controlled by the CPU serves for storing video data or the like. The unit 68 may also used for temporarily storing, thus it works like a cache memory.

An optical system 74 is used to redirect the light from the object to be scanned onto the image sensor 72. The optical system 74 comprises a plurality of lenses and other optical means allowing the regulation of the focusing angle, depth or the like. In an evaluating electronic module 4 the signal from the image sensor is prepared as a digital video stream and sent to the CPU that controls the further processing. For proper usage, said camera device 2 comprises an input module 70 in form of a keyboard, touch screen or joystick for instance. Herewith a user may control the functionality of said camera device 2. A module for defining 60 a size and position of a window within the scanning area is also being controlled by the CPU.

Furthermore, it is imaginable that the camera device 2 can be included in a mobile device like a mobile phone, PDA or similar.

A module for extracting 62 a desired window area is also connected to the CPU and may provides the display 66 with displayable video data used for controlling issues, for instance.

Even though the invention is described above with reference to embodiments according to the accompanying drawings, it is clear that the invention is not restricted thereto but it can be modified in several ways within the scope of the appended claims.

1. Method for extracting a plurality of sub-windows of a scanning area of an external object to be scanned, by means of a digital video camera providing a digital video stream of said scanning area, comprising the steps of:
defining a size and a position for each of one or more sub-windows from said plurality of sub-windows representing one or more regions of interest within said scanning area; and
extracting said defined one or more sub-windows from said digital video stream of said scanning area, wherein said extracting is performed substantially simultaneously if more than one sub-window from said plurality of sub-windows is defined;
wherein said extracting comprises interpolating said defined one or more sub-windows.

2. Method according to claim 1, wherein parameters are provided for extracting said defined one or more sub-windows, wherein said parameters are user input parameters.

3. Method according to claim 1, wherein said defining is automatically performed and is based on detecting of an event, said event being detected within said scanning area.

4. Method according to claim 3, wherein said event is detected and signalized on the basis of motion detection, voice tracking or the like within said scanning area.

5. Method according to claim 1, further comprising:
displaying said defined one or more sub-windows; and
storing video data relating to said defined one or more sub-windows.

6. A computer program product, comprising program code sections for carrying out the operations of claim 1, when said program is run on a processor-based device, a terminal device, a network device, a portable terminal, a consumer electronic device, or a mobile communication enabled terminal.

7. A computer program product, comprising program code sections stored on a machine-readable medium for carrying out the operations of claim 1, when said program product is run on a processor-based device, a terminal device, a network device, a portable terminal, a consumer electronic device, or a mobile communication enabled terminal.

8. A software tool, comprising program portions for carrying out the operations of claim 1, when said program is implemented in a computer program for being executed on a processor-based device, a terminal device, a network device, a portable terminal, a consumer electronic device, or a mobile communication enabled terminal.

9. A computer data signal embodied in a carrier wave and representing instructions, which when executed by a processor cause the operations of claim 1 to be carried out.

10. A digital camera device adapted for extracting a plurality of sub-windows of a scanning area of an external object to be scanned, said digital camera device providing a digital video stream of said scanning area, comprising:
a module for defining a size and a position for each of one or more sub-windows from said plurality of sub-windows representing one or more regions of interest within said scanning area;
a module for extracting said defined one or more sub-windows from said digital video stream of said scanning area, wherein said extracting module is adapted to perform said extracting substantially simultaneously if more than one sub-window from said plurality of sub-windows is defined, wherein said extracting comprises interpolating said defined one or more sub-windows.

11. Digital camera device according to claim 10, further comprising
a display for displaying said plurality of sub-windows and for displaying output data for a user;
a memory for storing video data relating to said plurality of sub-windows; a digital image sensor in connection with an optical system; and
an input module adapted to receive user input.

12. Digital camera device according to claim 10, further comprising a processor adapted to control all modules of said digital camera device.
